(19) United States
(12) Patent Application Publication
(10) Pub. No.: US 2004/0163295 A1
(43) Pub. Date: Aug. 26, 2004

(54) Apparatus to display decorative art and method thereof

(76) Inventors: Jill N. Fontana, Pottstown, PA (US); Krista L. Tillman, Pottstown, PA (US)

Correspondence Address: RATNERPRESTIA, P O BOX 980, VALLEY FORGE, PA, 19482-0980, US

(21) Appl. No.: 10/373,382

(22) Filed: Feb. 24, 2003

(51) Int. Cl. G09F 7/22

(52) U.S. Cl. 40/617; 40/611.02

(57) ABSTRACT

An apparatus for hanging decorative media comprising a body portion having a first member and a second member; a coupler to couple the first member to the second member at respective edge portions thereof such that the second member articulates with respect to the first member along the respective edge portions; a support to support the body portion with respect to a surface, the support being coupled to at least one of the first and second members; and a hanger to hang the decorative media therefrom, the hanger coupled to an interior portion of the body portion.

### FIELD OF THE INVENTION

The present invention relates, in general, to hangers or hanging assemblies. More specifically, the invention relates to an apparatus for hanging or displaying a sheet item of media art such as a quilt, tapestry, embroidery, needlepoint, blanket, rug, flag, cloth banner, curtain, glass beads, glass and like items.

### BACKGROUND OF THE INVENTION

Various types of hangers are known for displaying various items such as quilts, tapestry, curtains, strings of beads, rugs and other items, e.g., those items mentioned above. The items often are used to display such fabric art in various environments ranging from a personal home to a public museum. In a home, for instance, an item of fabric art may be displayed on a wall and changed as the seasons change, for example.

One of the problems with the conventional apparatus and systems for handling and displaying such decorative items is the need for more than one person to remove the present hanger apparatus and displayed items and replacing with a new item for display. Further, the conventional systems are difficult to use by individuals living alone and individuals suffering from medical conditions, such as arthritis or other medical conditions.

Thus, a need exists for decorative hangers that can be used by an unassisted individual or an individual with various medical deficiencies.

This invention addresses these needs.

### SUMMARY OF THE INVENTION

To meet this and other needs, and in view of its purposes, the present invention provides an apparatus for hanging decorative media.

In one embodiment of the invention, the apparatus comprises a body portion comprising a first member and a second member; a coupler to couple the first member to the second member at respective edge portions thereof such that the second member articulates with respect to the first member along the respective edge portions; a support to support the body portion with respect to a surface, the support being coupled to at least one of the first and second members; and a hanger to hang the decorative media therefrom, the hanger coupled to an interior portion of the body portion.

In another embodiment of the invention, the coupler is a hinge.

In yet another embodiment of the invention, the hanger is at least one rod, a first portion of the rod coupled to a first side portion of the body portion and a second portion of the rod coupled to a second side portion of the body portion.

In yet a further embodiment of the invention, the apparatus further comprises attaching means for attaching a cover to an outside surface of the body portion.

In still another embodiment of the present invention, the support is a frame member having a first vertical member and a second vertical member, the body portion coupled between the first vertical member and second vertical member.

It is understood that the foregoing general description and the following detailed description are exemplary, but are not restrictive, of the invention.

### BRIEF DESCRIPTION OF THE DRAWING

The invention is best understood from the following detailed description when read in connection with the accompany drawing. Included in the drawing are the following figures:

FIG. 1 is a perspective view of an exemplary embodiment of the present invention;

FIGS. 2A-2B are illustrations of the embodiment of FIG. 1 with a portion removed for clarity;

FIG. 3 is a plan view of the exemplary embodiment of FIG. 1;

FIGS. 4A and 4B are side views of alternative embodiments of the present invention;

FIG. 5 is a perspective view of a second exemplary embodiment of the present invention; and

FIGS. 6A and 6B are various views of is a further embodiment of the present invention.

### DETAILED DESCRIPTION OF THE INVENTION

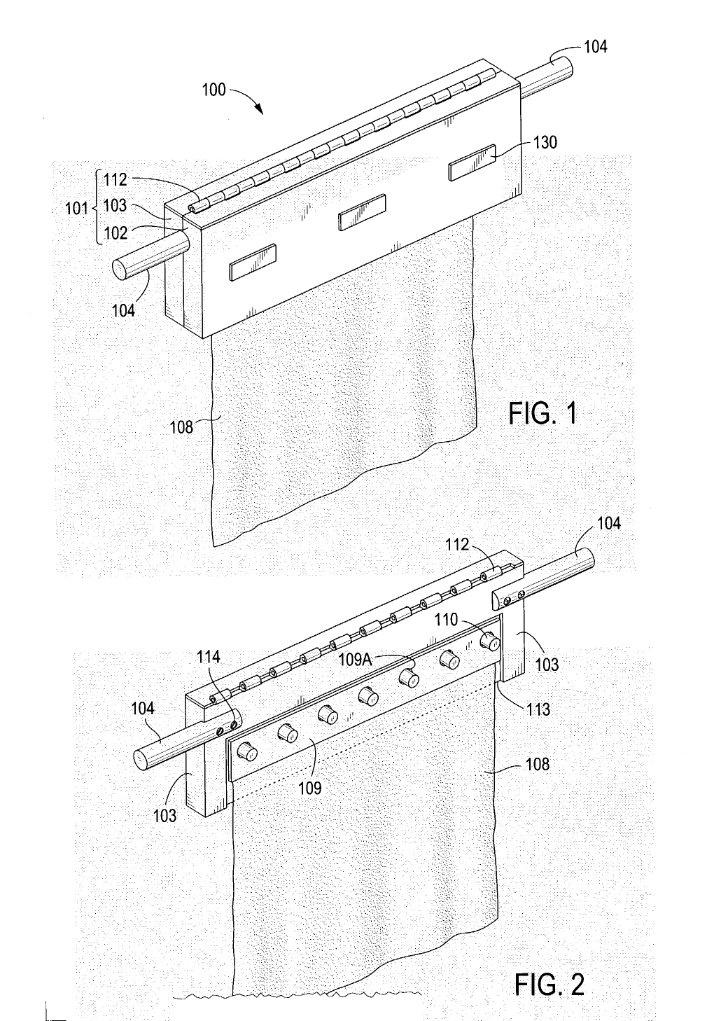

Referring now to the figures, wherein like references refer to like elements of the invention, FIG. 1 is a perspective view of a first exemplary embodiment of the present invention. As shown in FIG. 1, hanging apparatus 100 is comprised of body 101 with a first body member 102 and a second body member 103 each having a generally rectangular shape. Decorative media 108, such as a fabric or individual elements for example, is captive and extends from body 101. Details of how decorative media 108 is captive within body 101 are described below. Body 101 may also include a coupling 130 attached or embedded therein for detachably coupling a cover (not shown) to body 101 to enhance its aesthetic appeal. Coupling 130 may be a magnet, or a hook and loop material, for example.

First body member 102 and a second body member 103 are coupled to one another along respective edges with coupler 112, such as a hinge, so that first body portion 102 is able to articulate with respect to second body portion 103 to expose the interior of body 101. In one exemplary embodiment, body portions 102 and 103 may be formed from a variety of materials, such as wood, a polymer and/or metal, for example. It is also possible to form or mold body 101 such that coupler 112 is an integral part of first body member 102 and second body member 103. As such, coupler 112 may be a conventional hinge having a pin extending along its length, or may be another type of hinge such as a polymer web, for example, extending between first body member 102 and second body member 103. In one embodiment, hinge 112 is loaded such that it remains in place in both the open and closed positions in order to allow the user to concentrate her efforts on removing or installing decorative media 108 without the need to maintain hinge 112 in the open position, and also allows decorative media 108 to remain in place once installed.

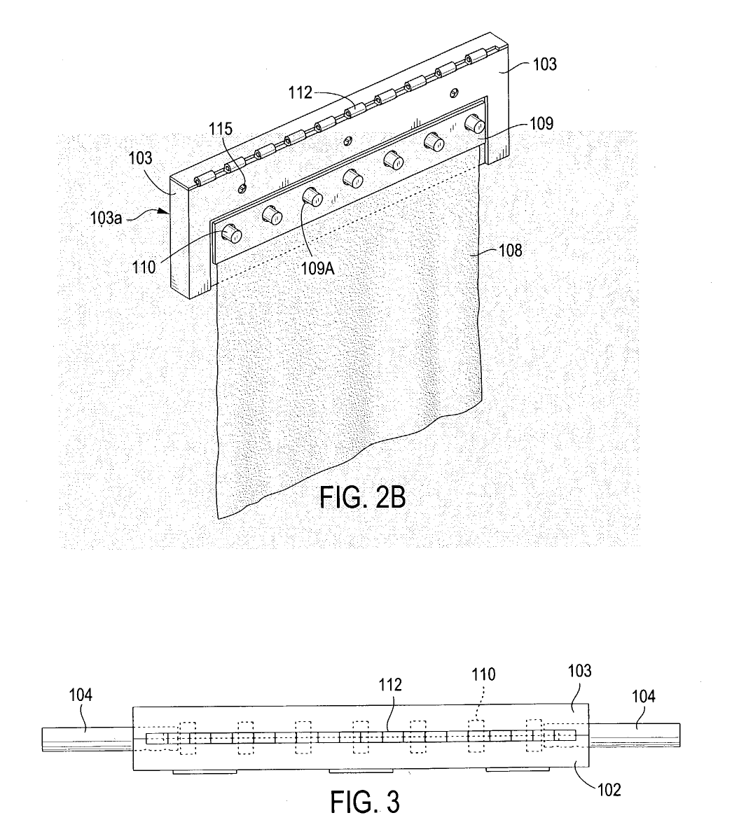

In order to hang body 101 from a desired surface, such as a wall (not shown), supports 104, such as metal, wood or polymer, for example extend from body 101 and are attached to conventional support brackets (not shown) extending from the desired surface. In one exemplary embodiment, supports 104 may be formed as rods, for example. Although two shorter support 104 are illustrated in FIG. 2 the invention is not so limited. It is also contemplated that a single support 104 may be used which extends through body 101. Further, and as shown in FIG. 2B, it is also contemplated that no support rods are used and that rear surface 103a of second body member 103 is attached to a mounting surface, such as a wall (not shown) using conventional means such as screws 115.

Referring now to FIG. 2A, the interior features of apparatus 100 are shown with body portion 102 removed for clarity. As shown in FIG. 2A, edge portion 109 of decorative media 108 has through holes 109A that mate with projections 110, such as pegs, which extend from the interior surface of body portion 103. Body 101 may include cutout portion 113 to accommodate a thickness of decorative media 108 to allow body portions 102 and 103 to close properly.

In one exemplary embodiment, projections 110 extend substantially orthogonal to the interior surface of body portion 103. The invention is not so limited, however, in that projections 110 may extend at an upward angle so that when body portion 102 is moved into a position to expose the interior of body 101, decorative media 108 remains in place until removed by the user.

Projections 110 may formed as a unitary part of body portions 103 and/or 102, or may be coupled thereto using conventional means, such as glue, screws, etc. Further, supports 104 may also be formed as a unitary part of body portion 103, for example, or may be individual parts attached to body portion 103 using any one of a variety of conventional means, such as screws 114. Although the illustration indicates that projections 110 have a generally circular cross section, the invention is not so limited. It is also contemplated that projections 110 may have other cross sectional configurations, such as square, rectangular, etc.

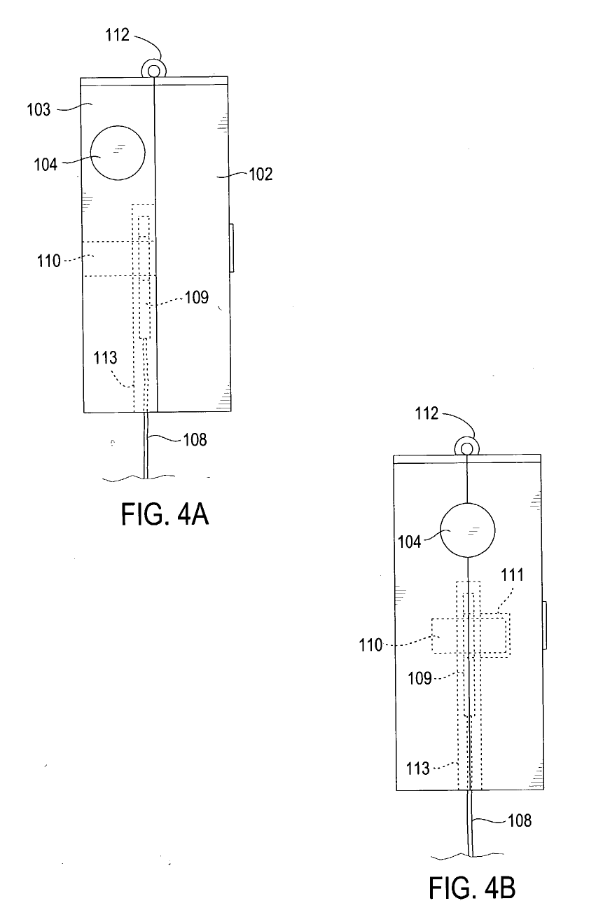

FIGS. 3 and 4A-4B illustrate a top view and side views of alternate embodiments of the present invention. As shown in FIGS. 3 and 4B, projections 110 may extend from body portion 103 into the interior 111 of body portion 102. In addition, support 104 may be positioned such that it interfaces with both body portions 102 and 103, although rod 104 is only coupled to one of these body portions.

As shown in FIG. 4A, projections 110 may also abut against the inner surface of body portion 102 and support 104 interfaces with only body portion 103. It is understood by those skilled in the art, that the features illustrated ion FIGS. 4A and 4B may be mixed as desired, and are thus not restrictive.

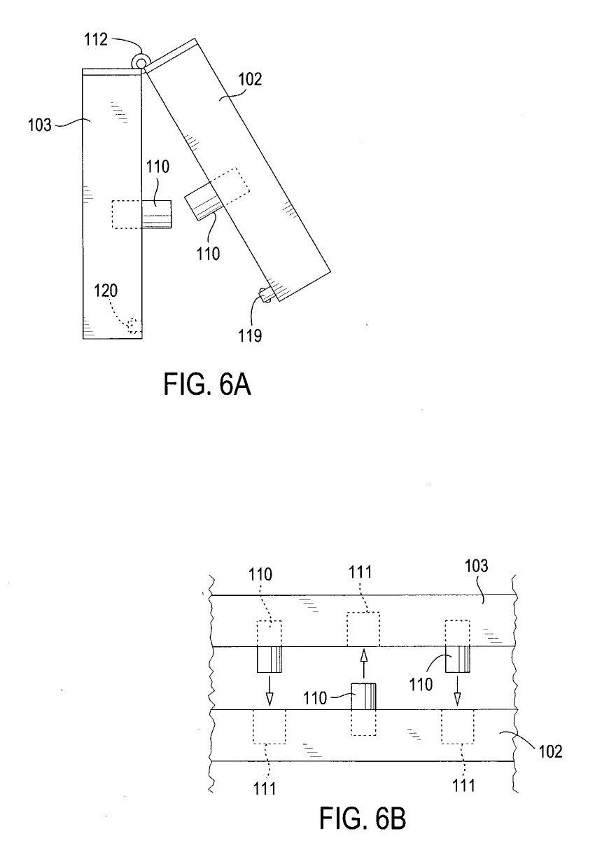

Referring now to FIGS. 6A and 6B, an alternative embodiment of the present invention is shown. In this embodiment, a portion of projections 110 are coupled to body portion 103 and the remaining projections are coupled to body portion 102. Each one of projections 110 mates with a respective receptacle 111 in the opposing body portion.

In another embodiment, a locking pin 119/receptacle 120 may be used order to maintain body portions 102 and 103 in a closed position, if desired. Locking pin 119 may be formed as part of body potion 102 or may be a separate element attached to body portion 102, for example.

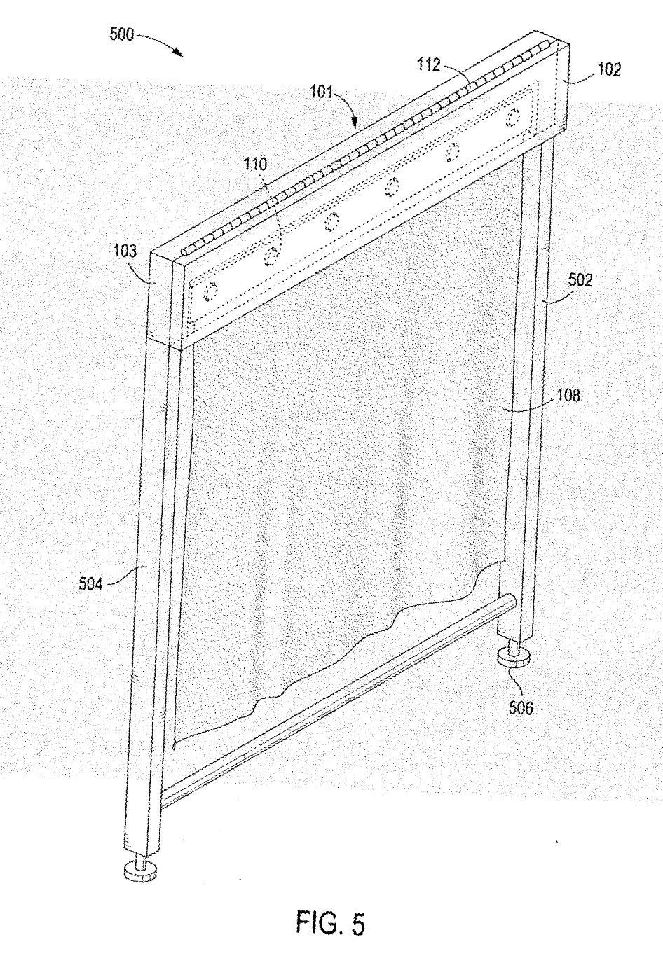

Referring now to FIG. 5, a second exemplary embodiment of the present invention is shown. As shown in FIG. 5, screen structure 500 comprises body 101 positioned between support members 502 and 504. Decorative media 108 hangs from body 101 and between support members 502 and 504 forming a decorative screen. Mounting feet or wheels 506 may be used to position or reposition screen 500 as desired. Although a single screen 500 is shown, it is contemplated that multiple screens 500 may be coupled to one another in a zig-zag panel form, for example to allow for a free standing arrangement. It is also contemplated that outriggers 510 may be added, if desired.

As can be appreciated from the above description and accompanying drawing, once the exemplary apparatus is mounted it need not be removed from its mounting surface to change the decorative media. It can also be appreciated that the exemplary apparatus may be used not only within the home, but also outside the home, such as in mobile homes, recreational vehicles (RV's) decks, gazebos, etc.

Although illustrated and described herein with reference to certain specific embodiments, the present invention is, nevertheless, not intended to be limited to the details shown. Rather, various modifications may be made in the details within the scope and range of equivalents of the claims and without departing from the spirit of the invention.

What is claimed:

1. An apparatus for hanging decorative media comprising:
a body portion comprising a first member and a second member,
coupling means for coupling the first member to the second member at respective edge portions thereof such that the second member articulates with respect to the first member along the respective edge portions;
support means for supporting the body portion with respect to a surface, the support means coupled to at least one of the first and second members; and
hanging means for hanging the decorative media therefrom, the hanging means coupled to an interior portion of the body portion.

2. The apparatus according to claim 1, wherein the coupling means is a hinge.

3. The apparatus according to claim 1, wherein the hinge is a spring loaded hinge to maintain the second member in at least one of an open position and a closed position with respect to the first body member.

4. The apparatus according to claim 1, further comprising securing means for securing the first member to the second member in a closed position.

5. The apparatus according to claim 1, wherein the support means is at least one rod, a first portion of the rod extending from a first side portion of the body portion and a second portion of the rod extending from a second side portion of the body portion.

6. The apparatus according to claim 1, wherein the support means is a pair of rods, a first one of the rods extending from a first side portion of the body portion and the second one of the rods extending from a second side portion of the body portion.

7. The apparatus according to claim 1, wherein the support means is coupled to a side portion of the body portion.

8. The apparatus according to claim 1, wherein the support means is coupled to one of an upper portion and a middle portion of the body portion.

9. The apparatus according to claim 1, wherein the hanging means comprises a plurality of members extending substantially orthogonal from an interior surface of at least one of the first body member and the second body member.

10. The apparatus according to claim 1, wherein the decorative media comprises a sheet like material having an upper portion with a plurality of apertures defined therein to engage at least a portion of the hanging means.

11. The apparatus according to claim 1, wherein the decorative media comprises a plurality of string like members each coupled to a panel, the panel having a plurality of apertures defined therein to engage at least a portion of the hanging means.

12. The apparatus according to claim 1, wherein the decorative media comprises at least one string like member, the at least one string like member engaging at least a portion of the hanging means.

13. The apparatus according to claim 1, further comprising attaching means for attaching a cover to an outside surface of the body portion.

14. The apparatus according to claim 13, wherein the attaching means is a least one magnet coupled to a surface of the body portion.

15. The apparatus according to claim 1, wherein the support means is a frame member having a first vertical member and a second vertical member, the body portion coupled between the first member and second member.

16. The apparatus according to claim 15, further comprising stabilizing means for stabilizing the frame member with respect to a mounting surface.

17. The apparatus according to claim 15, wherein the first member and the second member are substantially vertical.

18. The apparatus according to claim 1, wherein at least a portion of the hanging means is coupled to one of the first member and the second member.

19. The apparatus according to claim 1, wherein a first portion of the hanging means is coupled to the first member and a second portion of the hanging means is coupled the second member.

20. An apparatus for hanging decorative media comprising:
a body portion comprising a first member and a second member,
at least one frame member comprising a first vertical member and a second vertical member, the body portion coupled between the first vertical member and second vertical member;
coupling means for coupling the first member to the second member at respective edge portions thereof such that the second member articulates with respect to the first member along the respective edge portions;
hanging means for hanging the decorative media therefrom, the hanging means coupled to an interior portion of the body portion.

21. The apparatus according to claim 20, further comprising coupling means for coupling a first one of the at least one frame member to a further frame member.

22. An apparatus for hanging decorative media comprising:
a body portion defining an interior space and having a first member and a second member,
a hinge coupled to each of the first member and the second member along respective edge portions thereof;
a support coupled to at least one of the first member and the second member to support the body portion on a surface; and
a plurality of projections extending from at least one of the first member and the second member to hang the decorative media therefrom, the plurality of projections coupled to the interior space of the body portion.
